(19) United States
(12) Patent Application Publication
(10) Pub. No.: US 2014/0013616 A1
(43) Pub. Date: Jan. 16, 2014

(54) WATER LEVEL SENSING DEVICE AND CLOTHING DRYER INCLUDING THE SAME

(71) Applicant: SAMSUNG ELECTRONICS CO., LTD., Suwon-si (KR)

(72) Inventors: Sang Bin LEE, Suwon-si (KR); Tae Hyun Lee, Incheon (KR)

(73) Assignee: SAMSUNG ELECTRONICS CO., LTD., Suwon (KR)

(21) Appl. No.: 13/940,708

(22) Filed: Jul. 12, 2013

(30) Foreign Application Priority Data
Jul. 13, 2012 (KR) 10-2012-0076924

(51) Int. Cl. F26B 21/08

(52) U.S. Cl. CPC F26B 21/086
USPC 34/524; 34/73; 34/88

(57) ABSTRACT

A clothing dryer including a water level sensing device capable of detecting a water level of condensed water, using a simple structure. The clothing dryer includes a body, a drum rotatably installed in the body, the drum receiving objects to be dried, a base arranged beneath the body, a dehumidifying unit mounted to the base, to condense moisture contained in air discharged from the drum, a water container to collect condensed water formed in the dehumidifying unit, and a water level sensing device to detect a level of the condensed water collected in the water container. The water level sensing device includes a floating unit movable in accordance with a variation in the level of the condensed water. The water level sensing device also includes an electrode sensor to detect the level of the condensed water when electrically connected with the conductor of the floating unit.

### CROSS-REFERENCE TO RELATED APPLICATIONS

This application claims the priority benefit of Korean Patent Application No. 10-2012-0076924 filed on Jul. 13, 2012 in the Korean Intellectual Property Office, the disclosure of which is incorporated herein by reference.

### BACKGROUND

1. Field

Embodiments of the present disclosure relate to a water level sensing device capable of detecting a water level of condensed water, using a simple structure, and a clothing dryer including the same.

2. Description of the Related Art

A clothing dryer is an appliance to dry wet laundry in a washed state, using hot dry air.

Generally, clothing dryers are classified into a gas dryer and an electric dryer in accordance with power sources used therein. Also, clothing dryers are classified into an exhaustion type dryer and a condensation type dryer in accordance with systems to process moisture absorbed from objects to be dried.

The exhaustion type dryer exhausts wet air discharged from a drum to the outside of the dryer via an elongated exhaust duct.

On the other hand, the condensation type dryer utilizes a system in which wet air discharged from a drum passes through a heat exchanger, to remove moisture therefrom, and is then again sent to the drum, for circulation thereof. In the condensation type dryer, it may be difficult to use gas as a heat source because the flow of air in the condensation type dryer establishes a closed loop. For this reason, high maintenance costs may be required in that electricity is mainly used. Of course, the condensation type dryer may have an advantage of simple installation in that it may not need to use an exhaust duct because air is circulated between an object to be dried and the heat exchanger.

Condensed water is formed in a process of removing moisture from moist air by a dehumidifying unit. The condensed water is collected in the base of a clothing dryer. When a certain amount of condensed water is collected, it is removed from the base by a pump.

In order to measure an amount of condensed water, a water level sensing device to detect a water level of condensed water is provided. Research is being conducted into such a water level sensing device.

### SUMMARY

Therefore, it is an aspect of the present disclosure to provide a clothing dryer including a water level sensing device capable of easily detecting a water level of condensed water, using a simple structure.

Additional aspects of the disclosure will be set forth in part in the description which follows and, in part, will be apparent from the description, or may be learned by practice of the disclosure.

In accordance with one aspect of the present disclosure, a clothing dryer includes a body, a drum rotatably installed in the body, the drum receiving objects to be dried, a base arranged beneath the body, a dehumidifying unit mounted to the base, to condense moisture contained in air discharged from the drum, a water container to collect condensed water formed in the dehumidifying unit, and a water level sensing device to detect a level of the condensed water collected in the water container, wherein the water level sensing device includes a floating unit movable in accordance with a variation in the level of the condensed water, the floating unit including a conductor, and an electrode sensor to detect the level of the condensed water when electrically connected with the conductor of the floating unit.

The clothing dryer may further include a pump to pump, from the water container, the condensed water collected in the water container.

The pump may operate to pump the condensed water in the water container when the conductor comes into contact with the electrode sensor, thereby discharging the condensed water out of the water container.

The floating unit may further include a flotation member to be floated on the condensed water in the water container by buoyancy in accordance with the level of the condensed water. The conductor may be arranged at a top portion of the flotation member.

The conductor may be arranged on at least a portion of an outer surface of a body of the floating unit.

The clothing dryer may further include a water container cover to cover a top portion of the water container.

The electrode sensor may be mounted to the water container cover.

The electrode sensor may be mounted to the water container, to be downwardly protruded from the water container cover.

The clothing dryer may further include a water container bottom plate to cover a bottom portion of the water container.

The water container bottom plate may include a floating guide to guide the floating unit to move in accordance with the variation in the level of the condensed water.

The floating guide may include a water hole to allow the condensed water to be introduced into and discharged from the floating guide such that the condensed water in the floating guide always has a level equal to the level of the condensed water in the water container.

The water container may be arranged at one portion of the base.

The base may have a bottom inclined toward the water container to allow the condensed water formed in the dehumidifying unit to flow into the water container.

In accordance with another aspect of the present disclosure, a clothing dryer includes a base, a water container to collect condensed water formed at the base, an electrode sensor mounted to a top portion of the water container, and a floating unit movable in accordance with a variation in the level of the condensed water collected in the water container, wherein the floating unit includes a conductor to be detected by the electrode sensor.

The floating unit may further include a flotation member to be floated on the condensed water.

The conductor may be arranged at a top portion of the flotation member.

In accordance with another aspect of the present disclosure, a clothing dryer includes a base, a water container to collect condensed water formed at the base, a pump to pump the condensed water collected in the water container, an electrode sensor mounted to a top portion of the water container, and a conductor movable in accordance with a variation in a level of the condensed water collected in the water container, wherein, when the conductor is upwardly moved to come into contact with the electrode sensor in accordance with the varied level of the condensed water, the pump operates to pump the condensed water out of the water container.

In accordance with another aspect of the present disclosure, a water level sensing device to detect a water level of a water container receiving water includes an electrode sensor mounted to a top portion of the water container, and a conductor movable in accordance with a variation in a level of water received in the water container, wherein the conductor is movable in accordance with the water level variation, to be coupled with or separated from the electrode sensor.

The conductor may be floatable on the water by buoyancy.

The conductor may include a flotation member, to be floatable on the water by buoyancy.

The water container may include a floating guide to guide the movement of the conductor.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a view illustrating a configuration of a clothing dryer according to an exemplary embodiment of the present disclosure;

FIG. 2 is a view illustrating a structure of a base of the clothing dryer according to an exemplary embodiment of the present disclosure;

FIG. 3 is an enlarged view illustrating a configuration of a water level sensing device shown in FIG. 2;

FIG. 4 is a sectional view illustrating a base shown in FIG. 2; and

FIGS. 5 and 6 are views illustrating operation of the water level sensing device shown in FIG. 3.

### DETAILED DESCRIPTION

Hereinafter, embodiments of the present disclosure will be described with reference to the accompanying drawings.

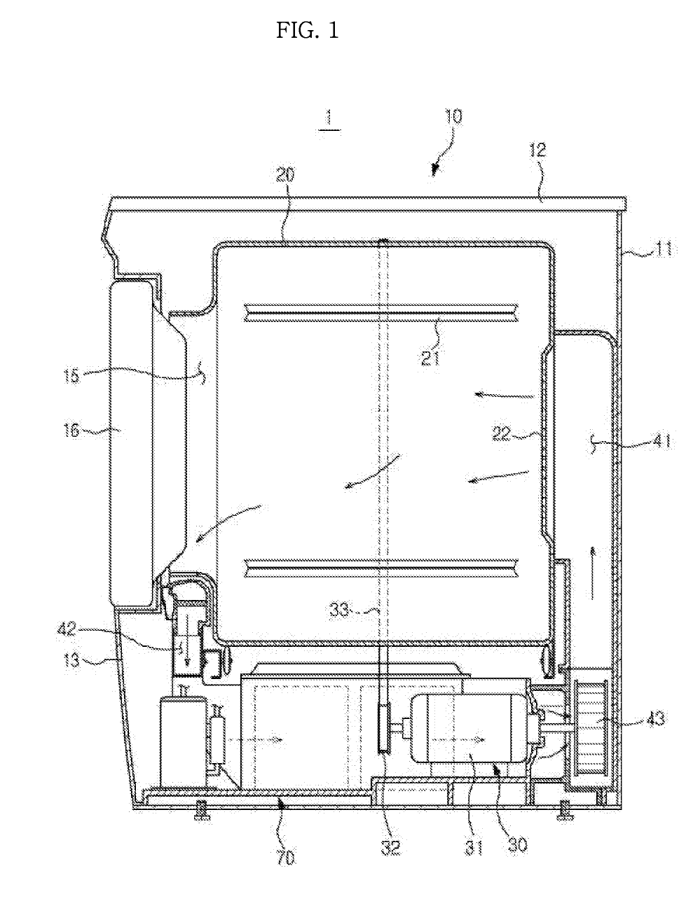

FIG. 1 is a view illustrating a configuration of a clothing dryer according to an exemplary embodiment of the present disclosure.

As shown in FIG. 1, the clothing dryer 1 may include a body 10, a drum 20, and a driving unit 30.

The body 10 may include a cabinet 11, a top cover 12 to cover the cabinet 11, and a front panel 13 disposed at a front portion of the cabinet 11.

An inlet opening 15 is formed through the front portion of the body 10, to allow objects, for example, laundry to be dried, to be loaded into the drum 20. A door 16 is pivotally coupled to the body 10 at a front portion of the inlet opening 15, to open or close the inlet opening 15.

The drum 20, which receives objects to be dried, is rotatably installed within the body 10. A plurality of lifters 21 is arranged on an inner circumferential surface of the drum 20 while being spaced apart from one another in a circumferential direction of the drum 20. The lifters 21 tumble objects to be dried, thereby causing the objects to be effectively dried.

The drum 20 is driven by the driving unit 30. The driving unit 30 may include a drive motor 31 mounted on a base 70. The driving unit 30 may further include a pulley 32 to receive a rotating force from the drive motor 31 and thus to rotate, and a belt 33 to connect the pulley 32 and the drum 20, and thus to transmit the rotating force from the drive motor 31 to the drum 20.

The drum 20 is open at a front portion thereof. Hot air inlets 22 are formed through a rear portion of the drum 20. Air heated by a dehumidifying unit 80 is introduced into the drum 20 through the hot air inlets 22.

The objects to be dried may be dried by air introduced into the drum 20.

Moist air discharged out of the drum 20 is introduced into the dehumidifying unit 80 via a discharge passage 42. The introduced air is dried while passing through the dehumidifying unit 80, and is then circulated into the drum 20 via an introduction passage 41.

Such airflow is induced by a blowing fan 43 installed at the portion of the introduction passage 41.

The discharge passage 42 is arranged at the front portion of the drum 20, to guide discharge of hot moist air emerging from the drum 20. A filter (not shown) may be installed in the discharge passage 42, to filter out foreign matter such as lint.

The introduction passage 41 is arranged at the rear portion of the drum 20. The introduction passage 41 communicates with the interior of the drum 20 through the hot air inlets 22 formed at the drum 20.

The blowing fan 43 is arranged within the introduction passage 41. The blowing fan 43 sucks hot dry air emerging from the dehumidifying unit 80, and then discharges the sucked air into the introduction passage 41. Thus, a circulating airflow to pass through the drum 20 is generated. The blowing fan 43 may be driven by the drive motor 31 which also drives the drum 20.

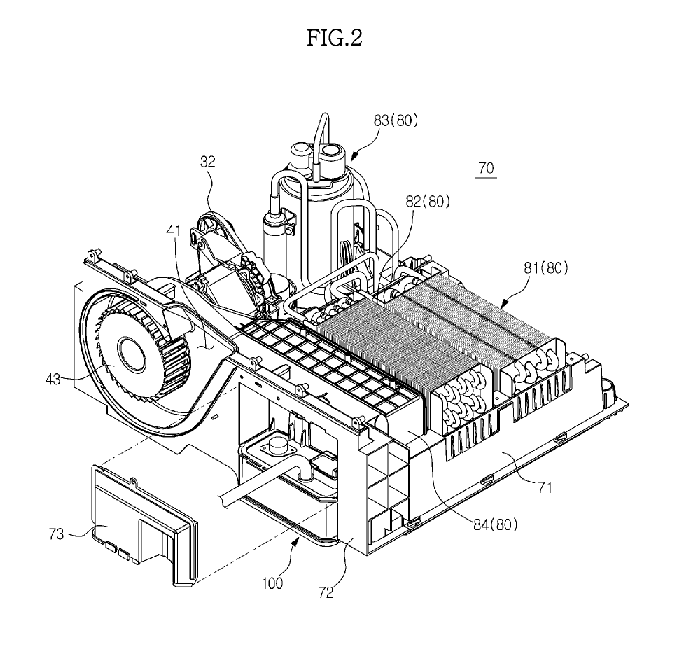

FIG. 2 illustrates a structure of the base of the clothing dryer according to an exemplary embodiment of the present disclosure. In particular, FIG. 2 is a perspective view showing a rear portion of the base.

As shown in FIG. 2, the base 70 is mounted beneath the drum 20. The base 70 includes a base body 71 to form an appearance of the base 70. The blowing fan 43 is mounted at a rear portion of the base body 71. A rear body 72 may also be mounted at the rear portion of the base body 71. A water container 100, which will be described later, is formed at the rear body 72.

The above-described dehumidifying unit 80, driving unit 30, and blowing fan 43 may be mounted to the base 70. In detail, the dehumidifying unit 80 and driving unit 30 may be mounted to the base body 71, whereas the blowing fan 43 may be mounted to the rear body 72.

A portion of the introduction passage 41 may be defined by a portion of the rear body 72 where the blowing fan 43 is mounted.

A rear cover 73 may be separately coupled to a portion of the rear body 72 where the water container 100 is formed, in order to protect the water container 100.

Although not shown, a base cover (not shown) may be coupled to a top portion of the base body 71 in order to cover the dehumidifying unit 80 and driving unit 30.

The dehumidifying unit 80 may include an evaporator 81, a condenser 82, and a compressor 83. Also, although not shown, the dehumidifying unit 80 may further include an expansion valve.

Hot moist air discharged from the drum 20 (FIG. 1) is introduced into the dehumidifying unit 80.

The introduced hot moist air first passes around the evaporator 81 of the dehumidifying unit 80. A refrigerant, which is in an expanded state due to pressure drop thereof, passes through the evaporator 81. The refrigerant absorbs heat while passing through the evaporator 81 and, as such, it is evaporated. On the other hand, the hot moist air passing around the evaporator 81 loses moisture while being cooled and, as such, it becomes low-temperature dry air. That is, hot moist air discharged from the drum 20 is changed into low-temperature dry air while passing around the evaporator 81.

Low-temperature dry air emerging from the evaporator 81 passes around the condenser 82. A refrigerant, which is in an overheated state due to compression thereof by the compressor 83, passes through the condenser 82. The overheated refrigerant discharges heat while passing through the condenser 82. On the other hand, the low-temperature dry air is heated while passing around the condenser 82 and, as such, it becomes hot dry air. That is, low-temperature dry air emerging from the evaporator 81 is changed into hot dry air while passing around the condenser 82.

Hot dry air emerging from the condenser 82 is guided to the introduction passage 41 via a guide passage 84. Hot dry air guided to the introduction passage 41 is fed toward the drum 20 along the introduction passage 41 by the blowing fan 43.

When a drying operation is begun, the drive motor 31 operates, thereby operating the drum 20 and blowing fan 43. The blowing fan 43 generates a flow of air. The airflow is changed into hot dry air while passing around the evaporator 81 and condenser 82, and is then introduced into the drum 20. The hot dry air introduced into the drum 20 absorbs moisture from objects loaded in the drum 20, thereby drying the objects. Then, the air becomes hot moist air. The hot moist air is again introduced into the dehumidifying unit 80 via the discharge passage 42, and is then changed into hot dry air. The hot dry air is then again introduced into the drum 20.

Condensed water may be formed during a process of removing moisture from hot moist air discharged from the drum 20 in accordance with a cooling operation of the evaporator 81.

Such condensed water may be collected in the water container 100 formed at the rear body 72 mounted at the rear portion of the base 70.

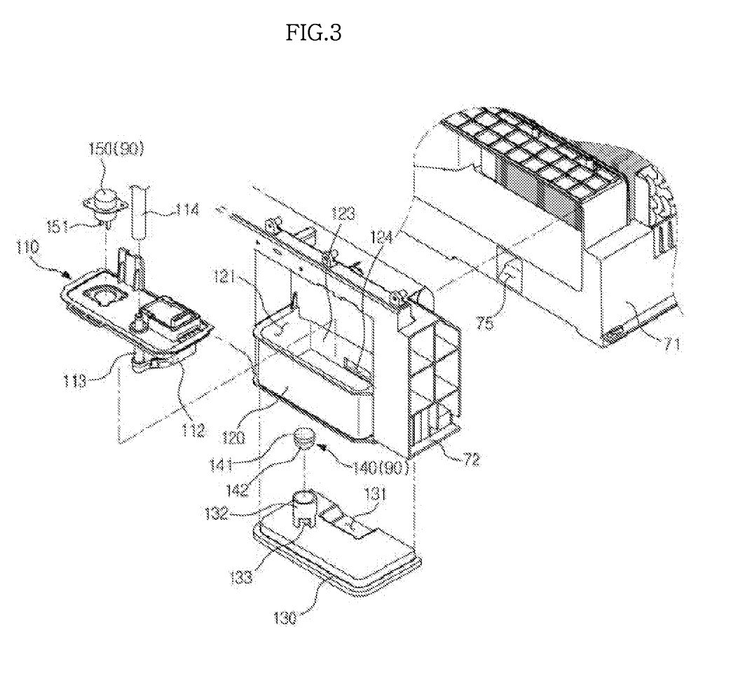

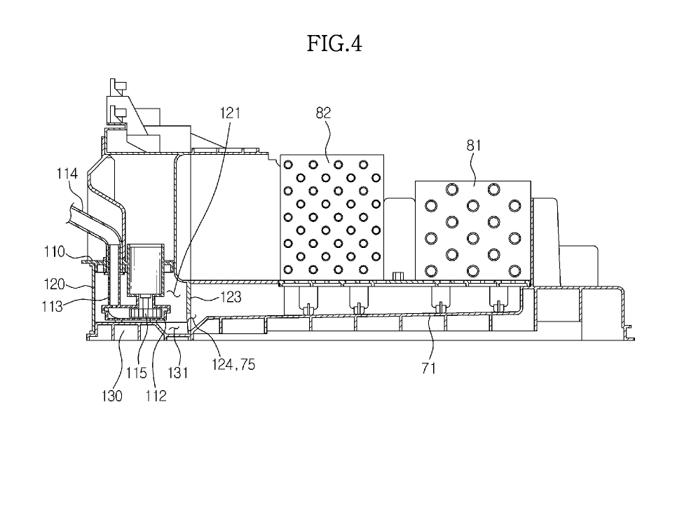

FIG. 3 is a view illustrating a configuration of the water level sensing device of FIG. 2 in an enlarged state. FIG. 4 is a sectional view illustrating the base of FIG. 2.

As shown in FIGS. 3 and 4, the water container 100 may be formed at the rear portion of the rear body 72. In an illustrated embodiment, a portion of the rear body 72 is recessed, and a side portion 120 of the water container 100 is integrally formed at the recessed portion of the rear body 72, to form the water container 100. Alternatively, the water container 100 may be formed separately from the rear body 72. In this case, the water container 100 may be mounted to the rear body 72.

In the illustrated case, the side portion 120 of the water container 100 is integrated with the rear body 72. A water container cover 110 is mounted to a top portion of the water container 100. Also, a water container bottom plate 130 is mounted to a bottom portion of the water container 100.

That is, the water container 100 may a front portion 120 and side portions 121 integrated with the rear body 72, and the water container cover 110 and water container bottom plate 130 which are formed separately from the rear body 72.

The water container 100 includes a rear portion 123 partially opened to form an inlet 124, through which condensed water formed in the base body 71 may be introduced into the water container 100. The base body 71 is formed with an outlet 75 at a portion thereof corresponding to the inlet 124 and, as such, condensed water may be introduced from the base body 71 into the water container 100.

The base body 71 includes a bottom inclinedly formed to allow condensed water to flow toward the outlet 75 and inlet 124. When viewed in the drawings, the inclination of the base 70 is formed such that the portion of the base 70 where the water container 100 is arranged is lower than the remaining portion of the base 70.

A water level sensing device 90 may be provided to detect the water level of the water container 100. The water level sensing device 90 may include an electrode sensor 150 and a floating unit 140. The water level sensing device 90 may further include a pump 115 to pump condensed water from the water container 100 in accordance with the water level detected by the water level sensing device 90.

The electrode sensor 150 and pump 115 are mounted to the water container cover 110. A pump housing 112 may be integrally formed at the water container cover 110, to accommodate the pump 115, to mount of the pump 115. That is, the pump 115 is mounted to the water container cover 110 in a state of being accommodated in the pump housing 115.

A discharge tube 114 may be mounted to the water container cover 110, to discharge condensed water pumped by the pump 115. For easy mounting of the discharge tube 114, a guide tube 113 may be integrally formed at one portion of the pump housing 112.

The electrode sensor 150 is mounted to the water container cover 110 such that an electrode 151 of the electrode sensor 150 is downwardly protruded from the water container cover 110.

The water container bottom plate 130 forms the bottom portion of the water container 100. The water container bottom plate 130 is formed with a recess 131 at a portion thereof corresponding to the inlet 124 in order to allow condensed water to be easily introduced into the water container 100 through the inlet 124.

The floating unit 140 may be mounted to the water container bottom plate 130. A floating guide 132 may be formed at the water container bottom plate 130, to guide upward or downward movement of the floating unit 140 caused by a variation in the water level of condensed water in the water container 100. The floating unit 140 is accommodated in the floating guide 132.

The floating guide 132 may be formed with a water hole 133 to allow condensed water to be easily introduced into and discharged from the floating guide 132.

The floating unit 140 includes a flotation member 142 to enable the floating unit 140 to be easily floated on the condensed water in the water container 100 by buoyancy.

A conductor 141 is coupled to a top portion of the flotation member 142. The conductor 141 is upwardly or downwardly moved together with the flotation member 142 in accordance with the water level of condensed water in the water container 100.

When the conductor 141 comes into contact with the electrode 151 of the electrode sensor 150 in accordance with upward movement thereof, they are electrically connected. When the conductor 141 is electrically connected to the electrode 151, the pump 115 operates under control of a controller (not shown), to pump condensed water out of the water container 100.

Condensed water pumped by the pump 115 is guided to a separate water tank (not shown) via the discharge tube 114.

The electrode 151 of the electrode sensor 150 may be formed to extend to a position lower than a water level at which condensed water overflows the water container 100.

In the illustrated embodiment, the floating unit 140 includes the flotation member 142, which forms a body of the floating unit 140, and the conductor 141 mounted to the top portion of the flotation member 142. Alternatively, the entire portion of the body of the floating unit 140 may be made of a conductive material. Of course, in this case, it may be necessary for the body of the floating unit 140 to have a shape enabling the floating unit 140 to be floated on condensed water without provision of a separate flotation member.

The body of the floating unit 140 may have a hollow structure. Alternatively, the body of the floating unit 140 is formed by the flotation member 142, and the conductor 141 is formed to cover an outer surface of the flotation member 142. In this case, the body of the floating unit 140 may also have a shape enabling the floating unit 140 to be floated on condensed water. In another embodiment, the conductor 141 may be thinly coated over the outer surface of the body of the floating unit 140, to prevent the weight of the floating unit 140 from being greatly increased.

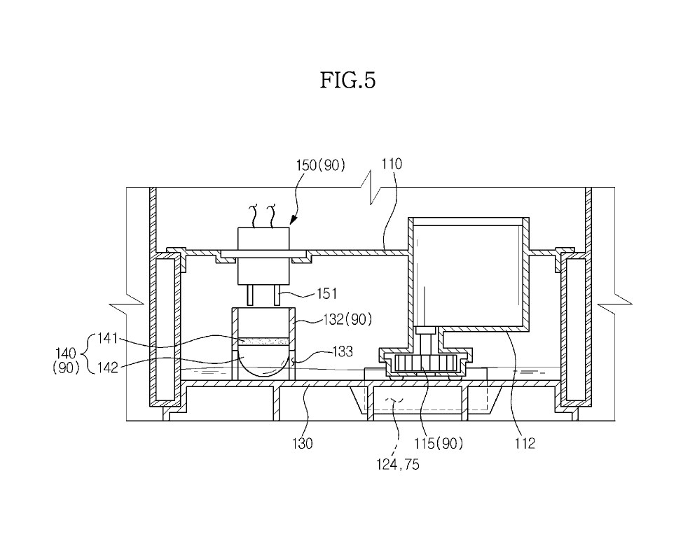

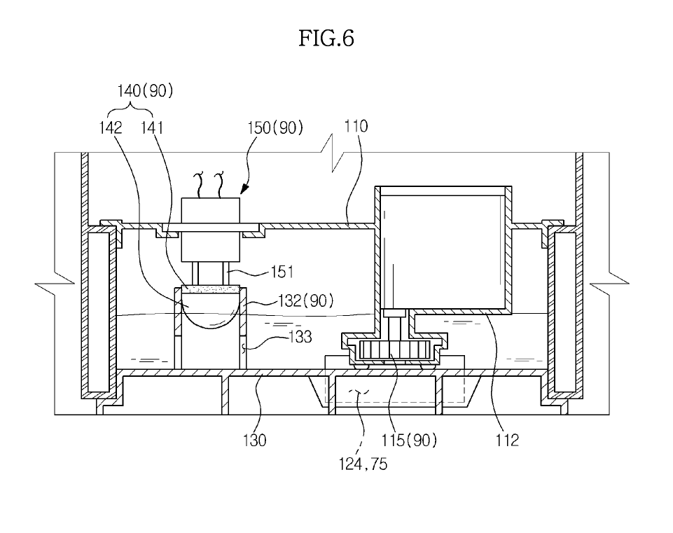

FIGS. 5 and 6 are views illustrating operation of the water level sensing device shown in FIG. 3.

As shown in FIG. 5, the floating unit 140 is positioned at a lower level than a maximum level until a sufficient amount of condensed water is collected in the water container 100, that is, until the water level of condensed water in the water container 100 reaches the maximum level. When the floating unit 140 is positioned at such a lower level, the conductor 141 is in a state of being spaced from the electrode 151. In this case, accordingly, the pump 115 does not operate.

On the other hand, when condensed water is sufficiently collected to fill the water container 100, as shown in FIG. 6, condensed water may be removed from the water container 100. In this case, the floating unit 140 is raised to the maximum level in accordance with the increased level of condensed water in the water container 100. Accordingly, the conductor 141 comes into contact with the electrode 151 and, as such, they are electrically connected.

When the conductor 141 and electrode 151 are electrically connected, the pump 115 operates under control of the controller (not shown). Accordingly, the condensed water in the water container 100 is pumped by the pump 115. The pumped condensed water is discharged into a separate water tank (not shown) via the discharge tube 114. As a result, the level of condensed water in the water container 100 is again lowered.

As apparent from the above description, in accordance with embodiments of the present disclosure, it may be possible to accurately and easily detect the level of condensed water, using the water level sensing device.

Through the structure of the water level sensing device according to each embodiment of the present disclosure, it may be possible to reduce manufacturing costs of the water level sensing device.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A clothing dryer comprising:
a body;
a drum rotatably installed in the body, the drum receiving objects to be dried;
a base arranged beneath the body;
a dehumidifying unit mounted to the base, to condense moisture contained in air discharged from the drum;
a water container to collect condensed water formed in the dehumidifying unit; and
a water level sensing device to detect a level of the condensed water collected in the water container,
wherein the water level sensing device comprises:
a floating unit movable in accordance with a variation in the level of the condensed water, the floating unit comprising a conductor, and
an electrode sensor to detect the level of the condensed water when electrically connected with the conductor of the floating unit.

2. The clothing dryer according to claim 1, further comprising:
a pump to pump, from the water container, the condensed water collected in the water container.

3. The clothing dryer according to claim 2, wherein the pump operates to pump the condensed water in the water container when the conductor comes into contact with the electrode sensor, thereby discharging the condensed water out of the water container.

4. The clothing dryer according to claim 1, wherein:
the floating unit further comprises a flotation member to be floated on the condensed water in the water container by buoyancy in accordance with the level of the condensed water; and
the conductor is arranged at a top portion of the flotation member.

5. The clothing dryer according to claim 1, wherein the conductor is arranged on at least a portion of an outer surface of a body of the floating unit.

6. The clothing dryer according to claim 1, further comprising:
a water container cover to cover a top portion of the water container.

7. The clothing dryer according to claim 6, wherein the electrode sensor is mounted to the water container cover.

8. The clothing dryer according to claim 7, wherein the electrode sensor is mounted to the water container, to be downwardly protruded from the water container cover.

9. The clothing dryer according to claim 1, further comprising:
a water container bottom plate to cover a bottom portion of the water container.

10. The clothing dryer according to claim 9, wherein the water container bottom plate comprises a floating guide to guide the floating unit to move in accordance with the variation in the level of the condensed water.

11. The clothing dryer according to claim 10, wherein the floating guide comprises a water hole to allow the condensed water to be introduced into and discharged from the floating guide such that the condensed water in the floating guide always has a level equal to the level of the condensed water in the water container.

12. The clothing dryer according to claim 1, wherein the water container is arranged at one portion of the base.

13. The clothing dryer according to claim 12, wherein the base has a bottom inclined toward the water container to allow the condensed water formed in the dehumidifying unit to flow into the water container.

14. A clothing dryer comprising:
a base;
a water container to collect condensed water formed at the base;
an electrode sensor mounted to a top portion of the water container; and
a floating unit movable in accordance with a variation in the level of the condensed water collected in the water container,
wherein the floating unit comprises a conductor to be detected by the electrode sensor.

15. The clothing dryer according to claim 14, wherein the floating unit further comprises a flotation member to be floated on the condensed water.

16. The clothing dryer according to claim 15, wherein the conductor is arranged at a top portion of the flotation member.

17. A clothing dryer comprising:
a base;
a water container to collect condensed water formed at the base;
a pump to pump the condensed water collected in the water container;
an electrode sensor mounted to a top portion of the water container; and
a conductor movable in accordance with a variation in a level of the condensed water collected in the water container,
wherein, when the conductor is upwardly moved to come into contact with the electrode sensor in accordance with the varied level of the condensed water, the pump operates to pump the condensed water out of the water container.

18. A water level sensing device to detect a water level of a water container receiving water, comprising:
an electrode sensor mounted to a top portion of the water container; and
a conductor movable in accordance with a variation in a level of water received in the water container,
wherein the conductor is movable in accordance with the water level variation, to be coupled with or separated from the electrode sensor.

19. The water level sensing device according to claim 18, wherein the conductor is floatable on the water by buoyancy.

20. The water level sensing device according to claim 18, wherein the conductor comprises a flotation member, to be floatable on the water by buoyancy.

21. The water level sensing device according to claim 18, wherein the water container comprises a floating guide to guide the movement of the conductor.

22. The clothing dryer according to claim 4, wherein the conductor is formed to cover an outer surface of the flotation member.

23. The clothing dryer according to claim 4, wherein the conductor is coated over an outer surface of the floating member.

24. The clothing dryer according to claim 15, wherein the conductor is formed to cover an outer surface of the flotation member.

25. The clothing dryer according to claim 15, wherein the conductor is coated over an outer surface of the floating member.

26. The water level sensing device according to claim 20, wherein the conductor is formed to cover an outer surface of the flotation member.

27. The water level sensing device according to claim 20, wherein the conductor is coated over an outer surface of the floating member.
